(19) United States
(12) Patent Application Publication
(10) Pub. No.: US 2020/0133424 A1
(43) Pub. Date: Apr. 30, 2020

(54) TOUCH DISPLAY APPARATUS

(71) Applicant: HannStar Display Corporation, Taipei City (TW)

(72) Inventors: Yen-Chung Chen, Taichung City (TW); Wei-Chih Hsu, Taichung City (TW)

(73) Assignee: HannStar Display Corporation, Taipei City (TW)

(21) Appl. No.: 16/662,010

(22) Filed: Oct. 23, 2019

(30) Foreign Application Priority Data
Oct. 31, 2018 (CN) 201811289066.1

(51) Int. Cl. G06F 3/041; G02F 1/1335; G02F 1/1333

(52) U.S. Cl. CPC G06F 3/0412; G02F 1/13338; G02F 1/133528

(57) ABSTRACT

The invention provides a touch display apparatus including a display device, a polarizer device, and a touch device. The polarizer device and the touch device are stacked on the display device. The touch device has a substrate with a thickness-direction phase retardation value Rth, and 0 nm≤|Rth|≤100 nm. The touch display apparatus has high display quality under the irradiation of an ambient beam.

### CROSS-REFERENCE TO RELATED APPLICATION

This application claims the priority benefit of China application serial no. 201811289066.1, filed on Oct. 31, 2018. The entirety of the above-mentioned patent application is hereby incorporated by reference herein and made a part of this specification.

### BACKGROUND OF THE INVENTION

### Field of the Invention

The invention relates to a touch display apparatus.

### Description of Related Art

A display panel and a touch device may be combined into a touch display apparatus. For example, the touch device includes a film sensor. The film sensor includes a substrate and a touch sensing layer formed on the substrate. In order to increase the application range of the touch display apparatus, the touch display apparatus needs to be flexible, and the touch device must also adopt a flexible substrate. However, a flexible substrate usually has optical anisotropy, and the optical anisotropy of the substrate of the touch device affects the display quality of the touch display apparatus.

### SUMMARY OF THE INVENTION

The invention is directed to a touch display apparatus with high display quality.

According to an embodiment of the invention, a touch display apparatus includes a display device, a polarizer device, and a touch device. The polarizer device and the touch device are stacked on the display device. The touch device has a substrate with a thickness-direction phase retardation value Rth, and 0 nm≤|Rth|≤100 nm.

According to an embodiment of the invention, a touch display apparatus includes a display device, a touch device, and a polarizer device. The touch device is disposed on the display device and has a substrate. The polarizer device is disposed between the substrate of the touch device and the display device. The substrate of the touch device has a planar phase retardation value R0, R0=(nx′−ny′)·d, nx′ and ny′ are respectively a maximum refractive index and a minimum refractive index of the substrate in an xy-plane of the substrate, direction x′ and direction y′ are located in the xy-plane of the substrate, nx′ is a refractive index of the substrate in direction x′, ny′ is a refractive index of the substrate in direction y′, d is a thickness of the substrate, the polarizer device has an absorption axis, the absorption axis of the polarizer device has an intersection angle θ with direction x′, and 0°<θ<90°.

In a touch display apparatus according to an embodiment of the invention, nx, ny, and nz are respectively refractive indices of the substrate on the x-axis, the y-axis, and the z-axis of the substrate, and

$$0 \leq \vert ( \frac{nx - nz}{2} ) + ( \frac{ny - nz}{2} ) \vert \leq 0.02 .$$

In a touch display apparatus according to an embodiment of the invention, the substrate has a thickness d and 5 μm≤d≤100 μm.

In a touch display apparatus according to an embodiment of the invention, the substrate of the touch device is disposed between the polarizer device and the display device.

In a touch display apparatus according to an embodiment of the invention, Rth>0, and the touch display apparatus further includes: a negative C plate disposed between the polarizer device and the display device.

In a touch display apparatus according to an embodiment of invention, the touch display apparatus further includes: a quarter wave plate disposed between the polarizer device and the negative C plate.

In a touch display apparatus according to an embodiment of the invention, Rth<0, and the touch display apparatus further includes: a positive C plate disposed between the polarizer device and the display device.

In a touch display apparatus according to an embodiment of invention, the touch display apparatus further includes: a quarter wave plate disposed between the polarizer device and the positive C plate.

In the touch display apparatus according to an embodiment of the invention, the polarizer device is disposed between the substrate of the touch device and the display device.

In a touch display apparatus according to an embodiment of the invention, the substrate of the touch device has a planar phase retardation value RO, R0=(nx′−ny′)·d, nx′ and ny′ are respectively a maximum refractive index and a minimum refractive index of the substrate in an xy-plane of the substrate, direction x′ and direction y′ are located in the xy-plane of the substrate, nx′ is a refractive index of the substrate in direction x′, ny′ is a refractive index of the substrate in direction y′, d is a thickness of the substrate, the polarizer device has an absorption axis, the absorption axis of the polarizer device has an intersection angle θ with direction x′, and 0°<θ<90°.

In a touch display apparatus according to an embodiment of the invention, 15°≤θ≤75°.

In a touch display apparatus according to an embodiment of the invention, the substrate of the touch device is polyimide.

In a touch display apparatus according to an embodiment of the invention, the display device includes a liquid crystal panel or an organic electroluminescent panel.

In a touch display apparatus according to an embodiment of the invention, the liquid crystal panel includes a transmissive liquid crystal panel or a transflective liquid crystal panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross section of a touch display apparatus of an embodiment of the invention.

FIG. 2 shows the relationship between the view angle θ(°) of a touch display apparatus and the reflectance R % of the touch display apparatus of an embodiment of the invention.

FIG. 3 is a cross section of a touch display apparatus of another embodiment of the invention.

FIG. 4 is a cross section of a touch display apparatus of yet another embodiment of the invention.

FIG. 5 is a cross section of a touch display apparatus of still yet another embodiment of the invention.

FIG. 6 is a cross section of a touch display apparatus of an embodiment of the invention.

FIG. 7 is a cross section of a touch display apparatus of another embodiment of the invention.

FIG. 8 is a cross section of a touch display apparatus of yet another embodiment of the invention.

FIG. 9 shows a substrate and a polarizer device of a touch device of the touch display apparatus of FIG. 8.

FIG. 10 is a cross section of a touch display apparatus of still yet another embodiment of the invention.

FIG. 11 is a cross section of a touch display apparatus of an embodiment of the invention.

FIG. 12 is a cross section of a touch display apparatus of another embodiment of the invention.

### DESCRIPTION OF THE EMBODIMENTS

Hereinafter, exemplary embodiments of the invention are described in detail, and examples of the exemplary embodiments are conveyed via figures. Wherever possible, the same reference numerals are used in the figures and the descriptions to refer to the same or similar parts.

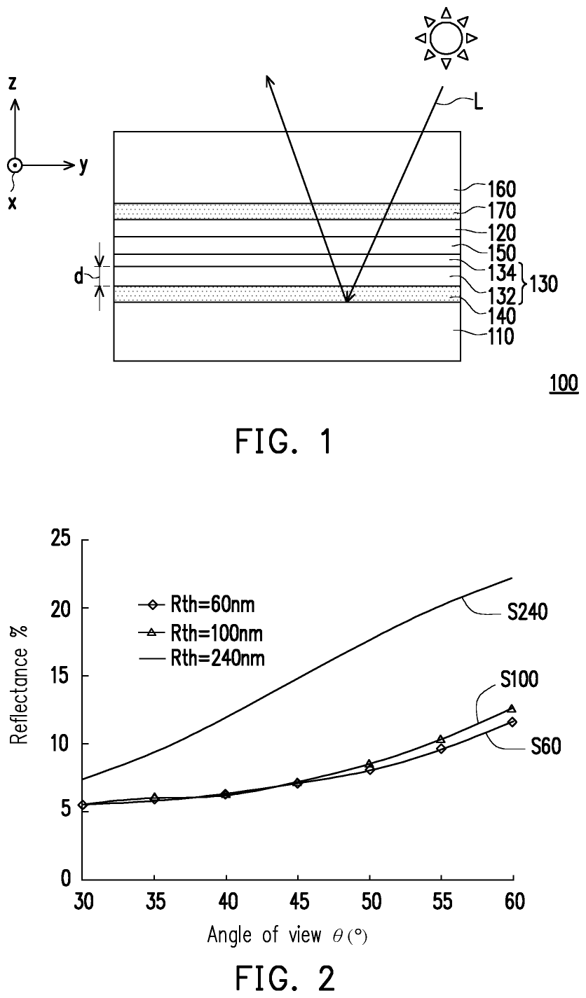

FIG. 1 is a cross section of a touch display apparatus of an embodiment of the invention. Referring to FIG. 1, a touch display apparatus 100 includes a display device 110, a polarizer device 120, and a touch device 130. The display device 110 includes a first substrate (not shown), a second substrate (not shown) opposite to the first substrate, a display medium (not shown), and a pixel array (not shown). The display medium and the pixel array are disposed between the first substrate and the second substrate. The display medium is disposed on the pixel array. The pixel array is used to drive the display medium. In the present embodiment, the display medium is capable of self-illumination. That is, the display device 110 may be optionally a self-emitting display panel. For example, the display medium may be an organic electroluminescent layer (e.g., an organic light-emitting diode layer), and the display device 110 may optionally be an organic electroluminescent display panel. However, the invention is not limited thereto. In another embodiment, the display device may also be a non self-emitting display screen, which is exemplified in the following paragraphs in conjunction with other figures.

The touch device 130 is disposed on the display device 110. For example, in the present embodiment, the touch device 130 may be a film sensor, and the film sensor may be optionally adhered on the display device 110 using an optical adhesive 140, but the invention is not limited thereto. The touch device 130 includes a substrate 132 and a touch-sensing layer 134 disposed on the substrate 132. In particular, the substrate 132 has a thickness-direction phase retardation value Rth,

$$Rth = [ ( \frac{nx - nz}{2} ) + ( \frac{ny - nz}{2} ) ] \cdot d ,$$

wherein nx, ny, and nz are respectively the refractive indices of the substrate 132 on the x-axis, the y-axis, and the z-axis of the substrate 132, and d is the thickness of the substrate 132 in the z direction. The x-axis, the y-axis, and the z-axis of the substrate 132 are respectively in direction x, direction y, and direction z. For example, in the present embodiment, the substrate 132 may be polyimide (PI), but the invention is not limited thereto.

The polarizer device 120 and touch device 130 are stacked on the display device 110. In the present embodiment, the touch device 130 may be disposed between the polarizer device 120 and the display device 110. That is, the substrate 132 having the thickness-direction phase retardation value Rth is disposed below the polarizer device 120, and the substrate 132 is located between the polarizer device 120 and the display device 110. In the present embodiment, the polarizer device 120 is, for example, a linear polarizer, but the invention is not limited thereto.

In the present embodiment, the touch display apparatus 100 may also optionally include a phase retardation layer 150 disposed between the polarizer device 120 and the display device 110. For example, in the present embodiment, the phase retardation layer 150 may be a quarter wave plate or a half wave plate, but the invention is not limited thereto. The touch display apparatus 100 may also optionally include a cover plate 160 disposed on the touch device 130, the polarizer device 120, and the display device 110. In the present embodiment, the cover plate 160 may be attached to other components (for example, the polarizer device 120) of the touch display apparatus 100 using an optical adhesive 170, but the invention is not limited thereto.

It should be noted that, in the present embodiment, by assigning the thickness-direction phase retardation value Rth of the substrate 132 of the touch device 130 to a certain value, the amount of an ambient beam L reflected by the display device 110 may be suppressed. Specifically, referring to FIG. 1, the substrate 132 of the touch display apparatus 100 has a thickness-direction phase retardation value Rth, and 0 nm≤|Rth|≤100 nm. Therefore, even if part of the display device 110 (for example, a data line, a scan line, a power line, etc. in the pixel array) is reflective, the amount of the ambient beam L reflected by the display device 110 (or, in other words, the reflectance of the touch display apparatus 100) may be acceptable, as exemplified in FIG. 2 below.

FIG. 2 shows the relationship between the view angle θ(°) of a touch display apparatus and the reflectance (%) of the touch display apparatus of an embodiment of the invention. Referring to FIG. 2, curve S60 shows the relationship between the view angle θ(°) and the reflectance of the touch display apparatus 100, wherein the substrate 132 of the touch display apparatus 100 has Rth and Rth=60 nm; curve S100 shows the relationship between the view angle θ(°) and the reflectance of the touch display apparatus 100, wherein the substrate 132 of the touch display apparatus 100 has Rth, and Rth=100 nm; curve S240 shows the relationship between the view angle θ(°) and the reflectance of the touch display apparatus 100, wherein the substrate 132 of the touch display apparatus 100 has Rth, and Rth=240 nm. As may be seen from FIG. 2, under a large view angle (for example, 45° to 60°), the touch display apparatus 100 having Rth=60 nm or Rth=100 nm has a lower reflectance (for example, about 5% to 13%), and the touch display apparatus 100 having Rth=240 nm has a high reflectance (for example, about 15% to 22%). Therefore, assigning the thickness-direction phase retardation value Rth of the substrate 132 of the touch device 130 in the range of 0 nm to 100 nm may indeed reduce the reflectance of the touch display apparatus 100 and reduce the amount of the ambient beam L reflected by the display device 110, thereby improving the display quality of the touch display apparatus 100 under irradiation by the ambient beam L.

Referring to FIG. 1, in the present embodiment, under the premise of satisfying 0 nm≤|Rth|≤100 nm, a suitable thickness d of the substrate 132 and a material having suitable nx, ny, and nz for the substrate 132 may be selected according to the requirement of the actual product. For example, in the present embodiment, 5 μm≤d≤100 μm,

$$0 \leq \vert ( \frac{nx - nz}{2} ) + ( \frac{ny - nz}{2} ) \vert \leq 0.02 ,$$

but the invention is not limited thereto.

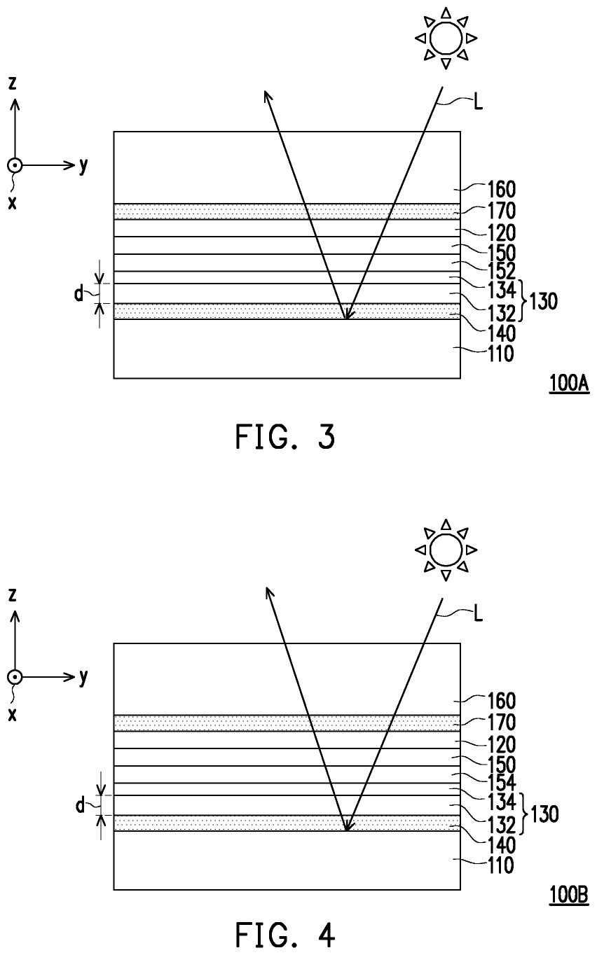

FIG. 3 is a cross section of a touch display apparatus of another embodiment of the invention. Referring to FIG. 1 and FIG. 3, a touch display apparatus 100A of FIG. 3 is similar to the touch display apparatus 100 of FIG. 1, and the difference between the two is that the substrate 132 of the touch display apparatus 100A of FIG. 3 has Rth>0, and the touch display apparatus 100A further includes a negative C plate 152 disposed between the polarizer device 120 and the display device 110. The phase retardation layer 150 is disposed between the polarizer device 120 and the negative C plate 152. The compensation effect by the negative C plate 152 may alleviate light leakage caused by the positive Rth value of the substrate 132 of the touch device 130.

FIG. 4 is a cross section of a touch display apparatus of yet another embodiment of the invention. Referring to FIG. 1 and FIG. 4, a touch display apparatus 100B of FIG. 4 is similar to the touch display apparatus 100 of FIG. 1, and the difference between the two is that the substrate 132 of the touch display apparatus 100B of FIG. 4 has Rth<0, and the touch display apparatus 100B further includes a positive C plate 154 disposed between the polarizer device 120 and the display device 110. The phase retardation layer 150 is disposed between the polarizer device 120 and the positive C plate 154. The compensation effect by the positive C plate 154 may alleviate light leakage caused by the negative Rth value of the substrate 132 of the touch device 130.

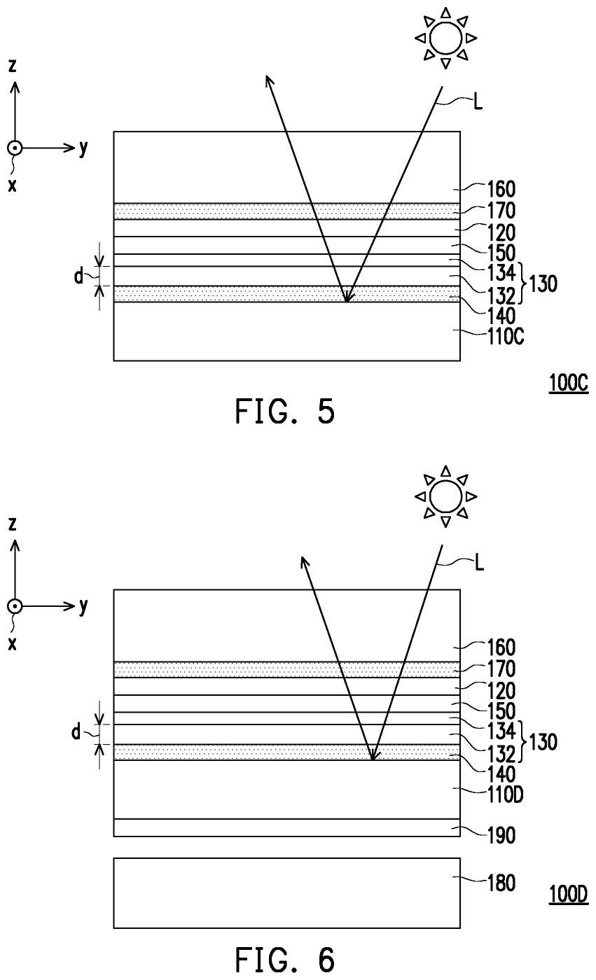

FIG. 5 is a cross section of a touch display apparatus of still yet another embodiment of the invention. Referring to FIG. 1 and FIG. 5, a touch display apparatus 100C of FIG. 5 is similar to the touch display apparatus 100 of FIG. 1. The difference between the two is that a display device 110C of the touch display apparatus 100C of FIG. 5 is different from the display device 110 of the touch display apparatus 100. Specifically, the display device 110C of the touch display apparatus 100C may be a reflective display, such as, but not limited to, a reflective liquid crystal display panel. The touch display apparatus 100C has similar functions and advantages as the touch display apparatus 100 which are not repeated herein.

FIG. 6 is a cross section of a touch display apparatus of an embodiment of the invention. Referring to FIG. 1 and FIG. 6, a touch display apparatus 100D of FIG. 6 is similar to the touch display apparatus 100 of FIG. 1. The difference between the two is that a display device 110D of the touch display apparatus 100D of FIG. 6 is different from the display device 110 of the touch display apparatus 100 of FIG. 1. Specifically, the display device 110D of the touch display apparatus 100D may be a transflective display, such as, but not limited to, a transflective liquid crystal panel. A backlight source 180 may be provided under the display device 110D. A polarizing device 190 is disposed between the backlight source 180 and the display device 110D, and the polarizing device 190 is a so-called lower polarizer. The absorption axis of the polarizer device 190 and the absorption axis of the polarizer device 120 may be parallel, orthogonal, or have other suitable intersection angles where the intersection angles are neither 0° nor 90°, depending on the display mode of the display device 110D. For example, the transflective display device may be a twisted nematic (TN), super twisted nematic (STN), vertical alignment (VA), in-plane switching (IPS), or fringe field switching (FFS) LCD panel or other suitable display modes. The touch display apparatus 100D has similar functions and advantages as the touch display apparatus 100 which are not repeated herein.

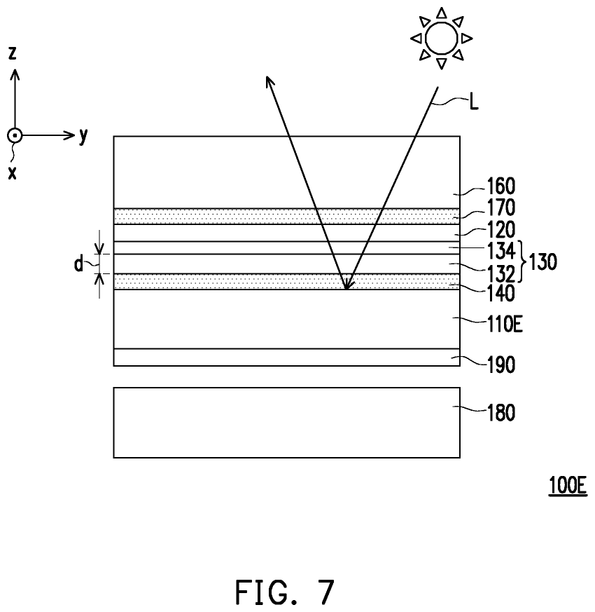

FIG. 7 is a cross section of a touch display apparatus of another embodiment of the invention. Referring to FIG. 6 and FIG. 7, a touch display apparatus 100E of FIG. 7 is similar to the touch display apparatus 100D of FIG. 6. The difference between the two is that a display device 110E of the touch display apparatus 100E of FIG. 7 is different from the display device 110D of the touch display apparatus 100D of FIG. 6. Specifically, the display device 110E of the touch display apparatus 100E may be a transmissive display device. For example, the transmissive display device may be a twisted nematic (TN), super twisted nematic (STN), vertical alignment (VA), in-plane switching (IPS), or fringe field switching (FFS) LCD panel or other suitable display modes. The touch display apparatus 100E has similar functions and advantages as the touch display apparatus 100 which are not repeated herein.

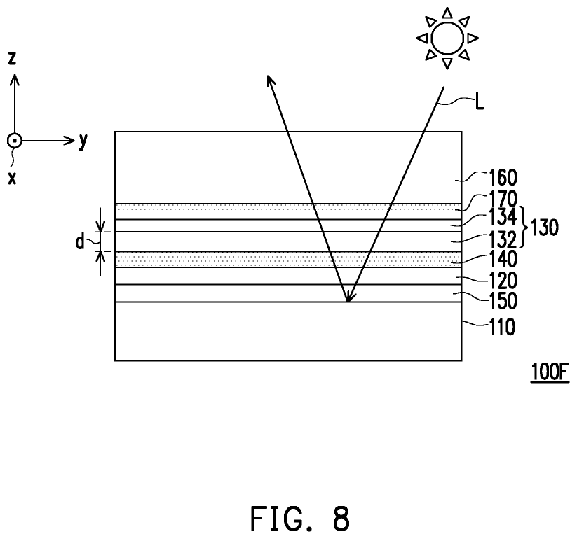

FIG. 8 is a cross section of a touch display apparatus of yet another embodiment of the invention. Referring to FIG. 1 and FIG. 8, a touch display apparatus 100F of FIG. 8 is similar to the touch display apparatus 100 of FIG. 1. The difference between the two is that the position of the touch device 130 of the touch display apparatus 100F of FIG. 8 is different from the position of the touch device 130 of the touch display apparatus 100 of FIG. 1. Specifically, in the present embodiment, the polarizer device 120 is disposed between the substrate 132 of the touch device 130 and the display device 110. That is, the touch device 130 is disposed on the polarizer device 120. Under this configuration, the ambient beam L transmitted toward the touch display apparatus 100F passes through the substrate 132 of the touch device 130 first before passing through the polarizer device 120, and the ambient beam L reflected by the display device 110 passes through the polarizer device 120 first before passing through the substrate 132 of the touch device 130. Therefore, the optical characteristics of the substrate 132 of the touch device 130 do not excessively affect the polarization state of the ambient beam L, thus the display quality of the touch display apparatus 100F is good even under the irradiation of the ambient beam L. In addition, since the optical characteristics of the substrate 132 of the touch device 130 do not excessively affect the polarization state of the ambient beam L, the material of the substrate 132 is more selective, thus facilitating the manufacture of the touch display apparatus 100F.

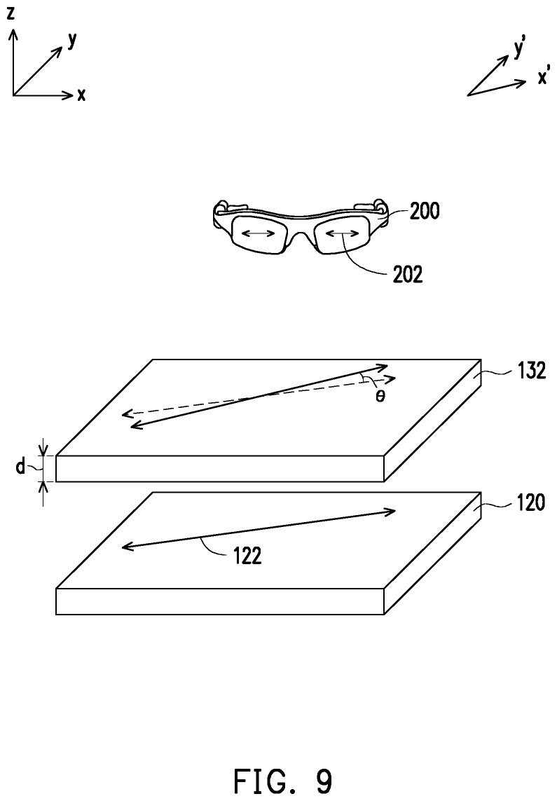

FIG. 9 shows the substrate 132 and the polarizer device 120 of the touch device 130 of the touch display apparatus 100F of FIG. 8. In the present embodiment, the substrate 132 has a planar phase retardation value R0, R0=(nx′−ny′)·d, nx′ and ny′ are respectively a maximum refractive index and a minimum refractive index of the substrate 132 in an xy-plane of the substrate 132, direction x′ and direction y′ are located in the xy-plane of the substrate 132, nx′ is a refractive index of the substrate 132 in direction x′, ny′ is a refractive index of the substrate 132 in direction y′, d is a thickness of the substrate 132, the polarizer device 120 has an absorption axis 122, the absorption axis 122 of the polarizer device 120 has an intersection angle θ with direction x′, and 0°<θ<90°. For example, in the present embodiment, 15°≤θ≤75°, but the invention is not limited thereto. Since the absorption axis 122 of the polarizer device 120 is not perpendicular or parallel to direction x′, linearly polarized light emitted from the polarizer device 120 will become circularly or elliptically polarized light after passes through the substrate 132 having the planar phase retardation value R0. Therefore, when a user watches the touch display apparatus 100F via the a polarizer device 200 (for example, polarized glasses), regardless of the angle between the absorption axis 202 of the polarizer device 200 (for example, polarized glasses) and the absorption axis 122 of the polarizer device 120, the user may see a screen with a good display quality, and the issue that the touch display apparatus 100F cannot be viewed under a specific view angle due to the user wearing the polarizer device 200 (for example, polarized glasses) is less likely to occur.

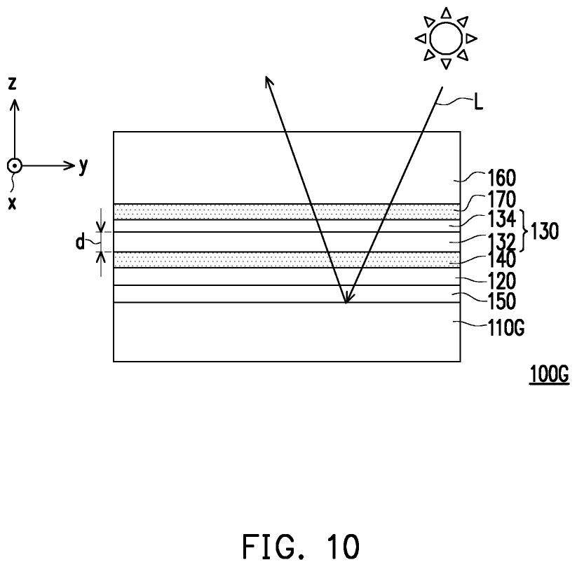

FIG. 10 is a cross section of a touch display apparatus of still yet another embodiment of the invention. Referring to FIG. 8 and FIG. 10, a touch display apparatus 100G of FIG. 10 is similar to the touch display apparatus 100F of FIG. 8. The difference between the two is that a display device 110G of the touch display apparatus 100G of FIG. 10 is different from the display device 110 of the touch display apparatus 100F of FIG. 8. Specifically, the display device 110G of the touch display apparatus 100G may be a reflective display device. The touch display apparatus 100G has similar functions and advantages as the touch display apparatus 100F, and is not repeated herein.

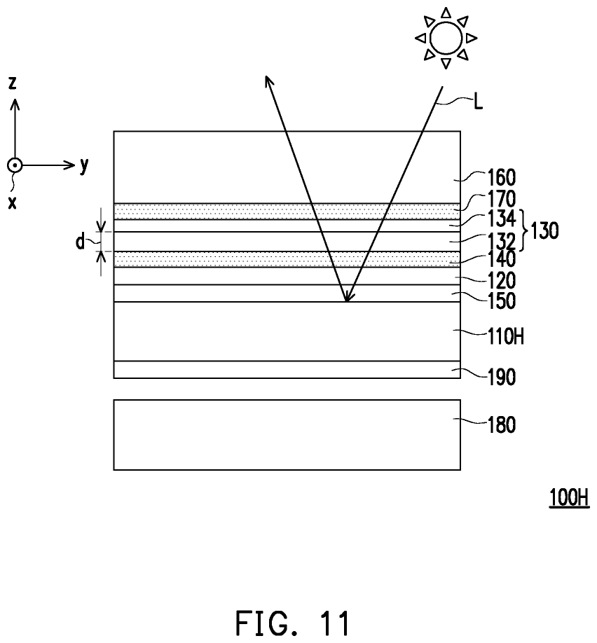

FIG. 11 is a cross section of a touch display apparatus of an embodiment of the invention. Referring to FIG. 8 and FIG. 11, a touch display apparatus 100H of FIG. 11 is similar to the touch display apparatus 100F of FIG. 8. The difference between the two is that a display device 110H of the touch display apparatus 100H of FIG. 11 is different from the display device 110 of the touch display apparatus 100F of FIG. 8. Specifically, the display device 110H of the touch display apparatus 100H may be a transflective display, and a backlight source 180 may be disposed under the display device 110H. A polarizing device 190 is disposed between the backlight source 180 and the display device 110H, and the polarizing device 190 is a so-called lower polarizer. The absorption axis of the polarizer device 190 and the absorption axis of the polarizer device 120 may be parallel, orthogonal, or have other suitable intersection angles where the intersection angles are neither 0° nor 90°, depending on the display mode of the display device 110H. The touch display apparatus 100H has similar functions and advantages as the touch display apparatus 100F which are not repeated herein.

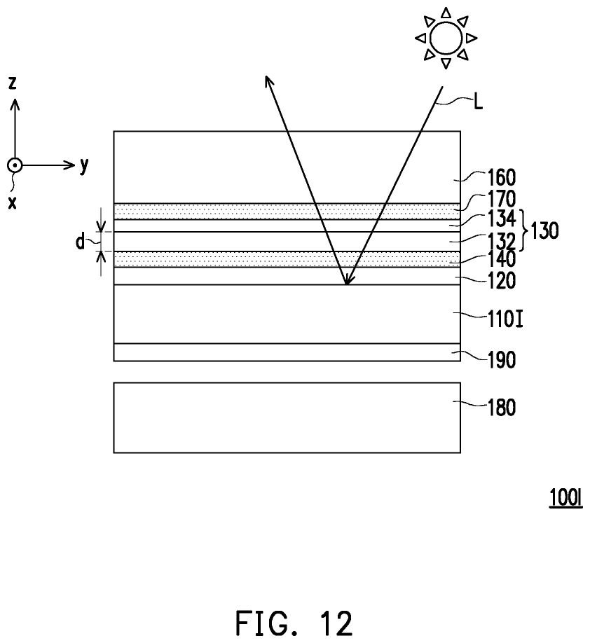

FIG. 12 is a cross section of a touch display apparatus of another embodiment of the invention. Referring to FIG. 11 and FIG. 12, a touch display apparatus 100I of FIG. 12 is similar to the touch display apparatus 100H of FIG. 11. The difference between the two is that a display device 110I of the touch display apparatus 100I of FIG. 12 is different from the display device 110H of the touch display apparatus 100H of FIG. 11. Specifically, the display device 110I of the touch display apparatus 100I may be a transmissive display device. For example, the transmissive display device may be a twisted nematic (TN), super twisted nematic (STN), vertical alignment (VA), in-plane switching (IPS), or fringe field switching (FFS) LCD panel or other suitable display modes. The touch display apparatus 100I has similar functions and advantages as the touch display apparatus 100F which are not repeated herein.

Lastly, it should be mentioned that: each of the above embodiments is only used to describe the technical solutions of the invention and is not intended to limit the invention; and although the invention is described in detail via each of the above embodiments, those having ordinary skill in the art should understand that: modifications may still be made to the technical solutions recited in each of the above embodiments, or portions or all of the technical features thereof may be replaced to achieve the same or similar results; the modifications or replacements do not make the nature of corresponding technical solutions depart from the scope of the technical solutions of each of the embodiments of the invention.

What is claimed is:

1. A touch display apparatus, comprising:
a display device;
a polarizer device and a touch device stacked on the display device;
wherein the touch device has a substrate with a thickness-direction phase retardation value Rth, and 0 nm≤|Rth|≤100 nm.

2. The touch display apparatus of claim 1, wherein nx, ny, and nz are respectively refractive indices of the substrate on an x-axis, a y-axis, and a z-axis of the substrate, and
$$0 \leq \vert ( \frac{nx - nz}{2} ) + ( \frac{ny - nz}{2} ) \vert \leq 0.02 .$$

3. The touch display apparatus of claim 1, wherein the substrate has a thickness d and 5 μm≤d≤100 μm.

4. The touch display apparatus of claim 1, wherein the substrate of the touch device is disposed between the polarizer device and the display device.

5. The touch display apparatus of claim 4, wherein Rth>0, and the touch display apparatus further comprises:
a negative C plate disposed between the polarizer device and the display device.

6. The touch display apparatus of claim 5, further comprising:
a quarter wave plate disposed between the polarizer device and the negative C plate.

7. The touch display apparatus of claim 4, wherein Rth<0, and the touch display apparatus further comprises:
a positive C plate disposed between the polarizer device and the display device.

8. The touch display apparatus of claim 7, further comprising:
a quarter wave plate disposed between the polarizer device and the positive C plate.

9. The touch display apparatus of claim 1, wherein the polarizer device is disposed between the substrate of the touch device and the display device.

10. The touch display apparatus of claim 9, wherein the substrate has a planar phase retardation value R0, R0=(nx′−ny′)·d, nx′ and ny′ are respectively a maximum refractive index and a minimum refractive index of the substrate in an xy-plane of the substrate, direction x′ and direction y′ are located in the xy-plane of the substrate, nx′ is a refractive index of the substrate in direction x′, ny′ is a refractive index of the substrate in direction y′, d is a thickness of the substrate, the polarizer device has an absorption axis, the absorption axis of the polarizer device has an intersection angle θ with direction x′, and 0°<θ<90°.

11. The touch display apparatus of claim 10, wherein 15°≤θ≤75°.

12. The touch display apparatus of claim 1, wherein the substrate of the touch device is a polyimide.

13. The touch display apparatus of claim 1, wherein the display device comprises a liquid crystal panel or an organic electroluminescent panel.

14. The touch display apparatus of claim 13, wherein the liquid crystal panel comprises a transmissive liquid crystal panel or a transflective liquid crystal panel.

15. A touch display apparatus, comprising:
a display device;
a touch device disposed on the display device and having a substrate; and
a polarizer device disposed between the substrate of the touch device and the display device;
wherein the substrate of the touch device has a planar phase retardation value R0, R0=(nx′−ny′)·d, nx′ and ny′ are respectively a maximum refractive index and a minimum refractive index of the substrate in an xy-plane of the substrate, direction x′ and direction y′ are located in the xy-plane of the substrate, nx′ is a refractive index of the substrate in direction x′, ny′ is a refractive index of the substrate in direction y′, d is a thickness of the substrate, the polarizer device has an absorption axis, the absorption axis of the polarizer device has an intersection angle θ with direction x′, and 0°<θ<90°.

16. The touch display apparatus of claim 15, wherein 15°≤θ≤75°.

17. The touch display apparatus of claim 15, further comprising:
a phase retardation layer that is a quarter wave plate or a half wave plate, wherein the polarizer device is disposed between the substrate of the touch device and the phase retardation layer.

18. The touch display apparatus of claim 15, wherein the substrate of the touch device is a polyimide.

19. The touch display apparatus of claim 15, wherein the display device comprises a liquid crystal panel or an organic electroluminescent panel.

20. The touch display apparatus of claim 19, wherein the liquid crystal panel comprises a transmissive liquid crystal panel or a transflective liquid crystal panel.
